(19) United States
(12) Patent Application Publication
(10) Pub. No.: US 2009/0080898 A1
(43) Pub. Date: Mar. 26, 2009

(54) Method and apparatus for reducing noise in a fiber-optic sensor

(75) Inventors: Duwayne Anderson, Saint Helens, OR (US); Shailesh Kumar Singh, Sherwood, OR (US)

Correspondence Address: GANZ LAW, P.C., P O BOX 2200, HILLSBORO, OR, 97123, US

(73) Assignee: Fiber SenSys LLC, Hillsboro, OR (US)

(21) Appl. No.: 11/902,608

(22) Filed: Sep. 24, 2007

(51) Int. Cl. H04B 10/00

(52) U.S. Cl. 398/140

(57) ABSTRACT

An optical detection system includes an optical transmit-receive system, an optical conduit in optical communication with the optical transmit-receive system, and an optical sensor in optical communication with the optical conduit. The optical transmit-receive system provides pulsed optical signals to the optical sensor by way of the optical conduit that have a maximum pulse width of about 100 nanoseconds and further have a maximum pulse width that is less than a maximum distance of reflection of the pulsed optical signals in the optical detection system to decrease false alarms.

### CROSS-REFERENCE TO RELATED PATENT PUBLICATIONS

The following patent publications and applications, the subject matter of each is being incorporated herein by reference in its entirety, are mentioned:

U.S. Published Patent Application No. 2007/0096007, by Anderson et al., entitled “Distributed fiber optic sensor with location capability,” published May 3, 2007;

U.S. Published Patent Application No. 2007/0069893, by Anderson, entitled “Polarization-based sensor for secure fiber optic network and other security applications,” published Mar. 27, 2007; and

U.S. patent application Ser. No. 11/826,914, by Thompson et al., entitled “Fiber Mat Sensor,” Atty. Docket 85900-2465007, filed Jul. 19, 2007.

### BACKGROUND

This patent application relates to sensing systems, and more particularly to optical fiber systems.

Optical fiber sensors may be used in perimeter security applications. In a multimode fiber-optic sensor, light travels along many modes in the optical fiber. In the case of coherent light, there is optical interference between the modes, resulting in a speckle pattern. Disturbances in the fiber result in strain that causes time-varying changes to the optical path lengths among the different modes. Because of the differential path lengths, disturbances of the fiber result in time variation in the speckle pattern. Thus, such a sensor works by monitoring the changes to the speckle pattern.

A single mode fiber-optic sensor, such a Mach-Zehnder interferometer, may also be used in a perimeter security application. A photodetector may detect the light transmitted through the interferometer. Disturbances may cause differential strain in the two arms of the interferometer. Because of differential strain, light traveling through one arm of the interferometer may arrive with a time-varying phase relative to the light traveling in the second arm. The time-varying optical signal may be converted into a time-varying electrical current to detect the presence of intruders.

However, since the multimode and single mode fiber-optic sensors rely upon phase measurements to detect the presence of intruders, the systems described above might be susceptible to laser noise. Typically, high quality lasers such as distributed feedback (DFB) lasers are used. However, narrow-bandwidth lasers suffer from standing waves. Typically, the optical fiber is connected to the laser via two connectors by a short piece of non-sensing single mode optical fiber of approximately one or two meters long, while the laser's coherence length is longer. As a result, standing waves may form between two connectors which connect the laser and the optical fiber. The standing waves are highly sensitive to environmental conditions both in the fiber and in the laser and produce signal noise in the non-sensing single mode optical fiber. The variations in intensity may be measured by the detector to indicate the presence of intruders.

One method to eliminate the standing waves when using narrow bandwidth lasers is to arrange the connectors further from one another, e.g., at a distance that is greater than the laser's coherence length. However, optical feedback, e.g., reflections into the laser cavity, are still difficult to avoid. The reflections might cause phase noise in the laser, which exhibits itself as signal in the sensor, giving false alarms. The optical feedback might be avoided by using optical isolators. However, optical isolators are expensive. Alternatively, the optical feedback might be avoided by using angled connectors. However, the angled connectors do not eliminate Rayleigh backscattering as do the optical isolators and they also add on cost to the entire system.

Another method to avoid the standing waves is to use lasers with a short coherence length, such as Fabry-Perot (FP) lasers. However, FP lasers suffer from mode-partition noise. Averaged over time, FP lasers operate at several frequencies. Over short periods of time, however, the laser's power may be concentrated in a smaller number of longitudinal modes. Thus, although the laser's output power remains stable over time, the power may be emitted from different modes, causing mode-partition noise, e.g., a phase noise. The mode-partition noise may introduce phase noise which might be perceived by the detector as a presence of intruders. The mode-partition noise of the FP laser may be eliminated by using a tight temperature control and precise design of the attachment points between the laser and the optical fiber. Such a solution requires complex modeling and, thus, is costly and time-consuming.

Thus, there is a need for an inexpensive solution using simple, inexpensive fiber-optic laser sensing systems which are not susceptible to optical noise.

### BRIEF DESCRIPTION

In one exemplary embodiment, an optical detection system includes an optical transmit-receive system, an optical conduit in optical communication with the optical transmit-receive system, and an optical sensor in optical communication with the optical conduit. The optical transmit-receive system provides pulsed optical signals to the optical sensor by way of the optical conduit that have a maximum pulse width of about 100 nanoseconds and further have a maximum pulse width that is less than a maximum distance of reflection of the pulsed optical signals in the optical detection system to decrease false alarms.

In another exemplary embodiment, an optical detection system includes an optical transmit-receive system, an optical conduit in optical communication with the optical transmit-receive system, and an optical sensor in optical communication with the optical conduit. The optical transmit-receive system provides a continuous wave optical signal to the optical sensor by way of the optical conduit to be returned to the optical transmit-receive system for detection. The continuous wave optical signal is selected to have a frequency such that there is no optical standing wave from any optical reflections within the optical detection system.

In another exemplary embodiment, an optical detection system includes an optical transmit-receive system, an optical conduit in optical communication with the optical transmit-receive system, and an optical sensor in optical communication with the optical conduit. The optical conduit includes a single mode optical fiber and the optical sensor includes a multimode optical fiber. In operation, the single mode optical fiber of the optical conduit provides spatial filtering of a time-varying speckle pattern from the optical sensor.

In another exemplary embodiment, an intruder is detected. A pulse of light is directed into an optical conduit. A portion of the pulse of light is split off into an optical sensor. The optical sensor is structured to reflect light back into the optical conduit. A return portion of the pulse of light is detected after having been reflected back by the optical sensor. The pulse of light has a width that is less than a minimum distance of reflection. The width of the pulse of light is also less than about 100 nanoseconds.

In another exemplary embodiment, an intruder is detected. A beam of continuous wave light is directed into an optical conduit. A portion of the beam of continuous wave light is split into an optical sensor. The optical sensor is structured to reflect light back into optical conduit. A return portion of the beam of continuous wave light is detected after having been reflected back by the optical sensor. The beam of continuous wave light has a frequency selected such that there is no optical standing wave from any optical reflections received during the detecting.

In another exemplary embodiment, an intruder is detected. Light is directed into a single mode optical fiber. A portion of the light is split off into an optical sensor. The optical sensor includes multimode optical fiber and is structured to reflect light back into the single mode optical fiber. A return portion of the light is detected after having been reflected back by the optical sensor. The single mode optical fiber provides spatial filtering of a speckle pattern of light from the optical sensor. The detecting is based on a time-varying signal obtained from the spatial filtering of the speckle pattern.

### BRIEF DESCRIPTION OF THE DRAWINGS

The invention is described herein, by way of example only, with reference to the accompanying FIGURES, in which like components are designated by like reference numerals.

FIG. 1A is a diagrammatic illustration of an optical detection system according to an embodiment of the current invention;

FIG. 1B is a diagrammatic illustration of an optical detection system according to an embodiment of the current invention;

FIG. 2A is a graphical illustration of a square laser pulse;

FIG. 2B is a graphical illustration of a triangular laser pulse;

FIG. 2C is a graphical illustration of a sinusoidal laser pulse;

FIG. 2D is a graphical illustration of continuous sinusoidal wave;

FIG. 3 is a diagrammatic illustration of an optical detection system according to an embodiment of the current invention; and

FIG. 4 is a diagrammatic illustration of an optical detection system according to an embodiment of the current invention.

### DETAILED DESCRIPTION

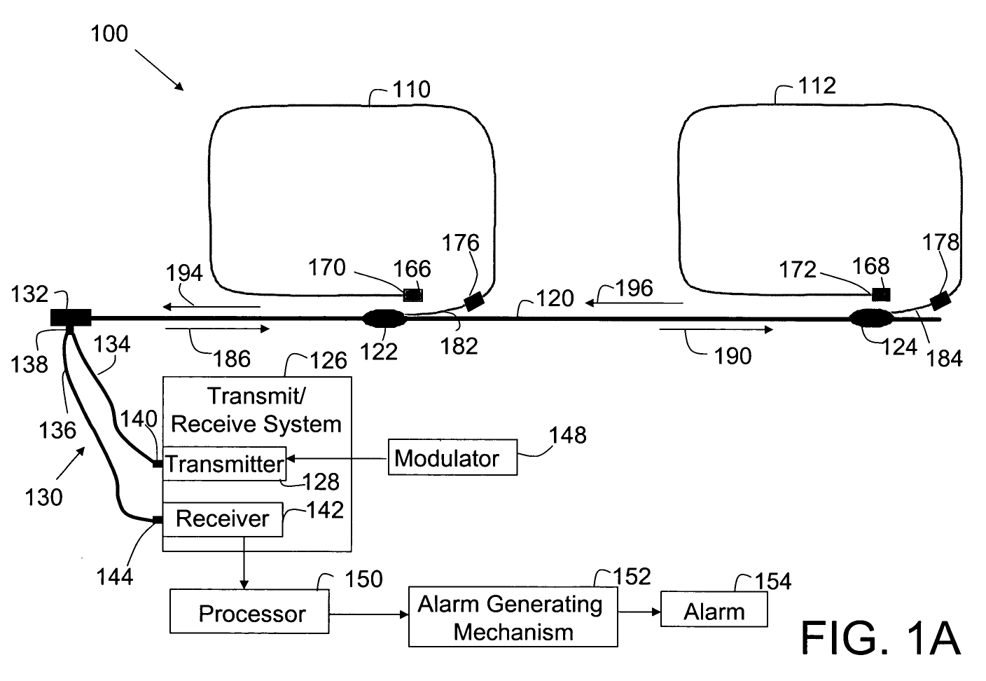

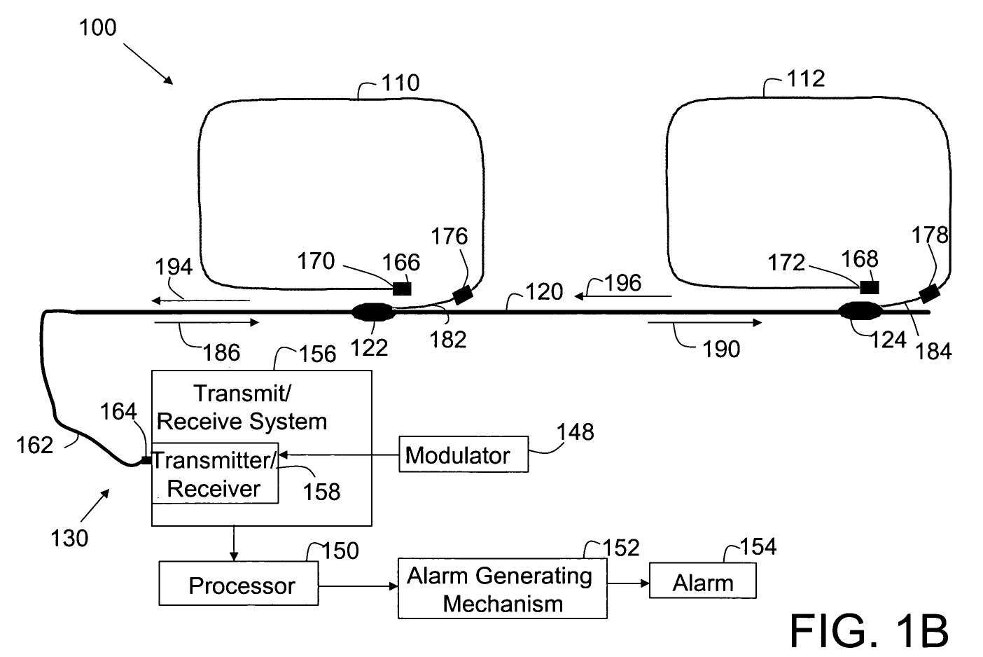

With reference to FIG. 1, in one exemplary embodiment, a fiber-optic detection system 100 may include a spatially distributed detection system including first, second optical sensors 110, 112. Each first, second optical sensor 110, 112 includes at least one length of optical fiber optically coupled to an optical conduit 120 at a respective first or second tap coupler 122, 124 to receive light signals from a transmit-receive system 126 including a light source or a transmitter 128. The transmitter 128 may include a pulsed laser, a continuous wave laser, or the like source of light. The transmitter 128 may be connected to the conduit 120 via an optical assembly 130 including a splitter 132. More specifically, first, second fiber portions 134, 136 may each be connected to the splitter 132 via a splitter connector 138. The first, second fiber portions 134, 136 may include non-sensing single mode optical fiber. The first fiber portion 134 may be connected to the transmitter 128 via a first control connector 140. The second fiber portion 136 may be connected to a receiver 142 via a second control connector 144. Examples of the laser may include a vertical cavity surface emitting laser (VCSEL), a Fabry Perot (FB) laser, a distributed feedback (DFB) laser, and the like. As described in greater detail below, a modulator, driver, function generator, or other controlling means 148 may manipulate at least one of a shape, a width, or a frequency of the transmitted laser signal so that the reflections do not interfere with the transmitted laser signals. A number of false alarms may be substantially minimized or entirely eliminated. In one embodiment, the modulator 148 may include a switch to turn the laser ON and OFF. This is an example of what is sometimes referred to as direct modulation. The modulator may be a direct modulator in some embodiments, but the invention is not limited to only direct modulation. For example, external modulators may be used for modulator 148 in some embodiments. Also, the position of the modulator 148 is only schematic. For example, some embodiments may include external modulators placed in output beams of optical transmitters. For example, if the laser is off or blocked for a substantial portion of the time during operation, spurious reflections have a reduced probability of entering back into the laser during operation. In addition, modulating the laser signal so that it is pulsed leads to an increased bandwidth and decreased coherence length of the signal, both of which may lead to an increase in a signal-to-noise ratio and a decrease in false alarms.

The optical receiver 142, optically coupled to the optical conduit 120, may receive optical signals from the first, second sensors 110, 112. The receiver 142 may include an optical detector, such as a photodiode or any other suitable detector, which may detect and convert the optical signals received from the first, second optical sensors 110, 112 into electrical signals. A processor 150 may receive electrical signals from the receiver 142 and analyze the received electrical signals to determine, for example, a presence of an event sensed by the first or second optical sensor 110, 112. Based on the analysis, an alarm generating mechanism 152 may generate an alarm 154, such as an audible alarm, a visual alarm or a text message, to be displayed at a remote station, and the like.

With reference to FIG. 1B, for a pulsed laser or a modulated continuous wave laser, a transmit-receive system 156 may include a single transmitter/receiver element 158, such as a semiconductor device, which may operate as a light source in a forward bias mode and a receiver in a reverse bias mode. During the light transmission, the transmitter/receiver element 158 may be forward biased and may transmit light pulses into the first, second optical sensors 110, 112. During the reception, the transmitter/receiver element 158 may be reversed biased and may sense the light signals returned from the first, second optical sensors 110, 112. The transmitter/receiver element 158 may be connected to the optical conduit 120 via a single piece 162 of a single mode non-sensing optical fiber via a single control connector 164. Thus, as compared to the embodiment of FIG. 1A, the embodiment of FIG. 1B may eliminate at least the splitter, three fusion splices and an optical detector by using a semiconductor device as the transmitter/receiver element.

Although not shown in FIGS. 1A and 1B, the spatially distributed detection system 100 may include three, four or even up to fifty or more optical sensors each optically coupled to a different respective position of the optical conduit 120. The transmit-receive system 126, 156 and modulator 148 may comprise an integrated unit.

In one embodiment, first, second mirrors 166, 168 each may be disposed at first, second end 170, 172 of the respective first, second optical sensor 110, 112. The first, second mirrors 166, 168 may be either formed on the end 170, 172 of the respective first, second optical sensor 110, 112, or may be a component that is attached to the end 170, 172 of the respective first, second optical sensor 110, 112, or may include a layer of reflective material disposed about the end 170, 172 of the respective first, second optical sensor 110, 112. First, second inline polarizers 176, 178 each may be optically coupled to a portion 182, 184 of the respective first, second optical sensor 110, 112. For example, the first, second inline polarizers 176, 178 may be separate components, each attached to the portion 182, 184 of the respective first, second optical sensor 110, 112.

The transmitter 128 may include a depolarizer to provide a depolarized, time-varying source of light indicated by an arrow 186. The first, second tap couplers 122, 124 each may split off a portion of light transmitted in the optical conduit 120 to direct the light into the respective first, second optical sensor 110, 112. If a great number of optical sensors are coupled to the optical conduit 120 of the detection system 100, each tap coupler may split off small portions of the transmitted light that reaches it. For example, the first tap coupler 122 may split off between approximately 2% and approximately 5% of the transmitted light 186 into the first optical sensor 110.

More specifically, a light signal from the transmitter 128 travels along the optical conduit 120. When the light signal 186 reaches the first tap coupler 122, a portion of the light is split off into the first optical sensor 110 and the rest of the light, indicated by an arrow 190, travels further in the optical conduit 120. The light, split off at the first tap coupler 122, is directed into the first optical sensor 110 at the portion 182. The light passes through the first inline polarizer 176 and travels along the length of the first optical sensor 110 to the first mirror 166. The light reflects back off the first mirror 166, passes again through the first inline polarizer 176 and into the optical conduit 120 through the first tap coupler 122 as a first return light 194 to be received by the receiver 142.

The portion 190 of the light signal transmitted from the transmitter 128 continues beyond the first tap coupler 122 into the second optical sensor 112. The process described above in relationship to the first optical sensor 110 may be repeated for the second optical sensor 112 and other optical sensors which may be disposed along the optical conduit 120. Correspondingly, a respective first, second return pulse 194, 196 of light is received from each optical sensor 110, 112 by the receiver 142 for a given light signal from the transmitter 128. For example, in one embodiment in which there are fifty optical sensors, fifty return light signals are received for each transmitted light signal. The processor 150 may receive electrical signals from the receiver 142 and process the received electrical signals to determine, for example, the presence of an event sensed by one or more optical sensors 110, 112. In one embodiment, the processor 150 may include a variety of algorithms to positively identify a location of each optical sensor, such as delaying the transmission of additional light signals from the transmitter 128 until after all light signals have been received by the receiver 142 after returning from all optical sensors. In that case, the first returned pulse will typically correspond to the first optical sensor disposed at a substantially known first location, the second returned pulse will typically correspond to the second optical sensor disposed at a substantially known second location, etc.

As long as the first, second optical sensors 110, 112 remain undisturbed, the amount of light 194, 196 returned from substantially equal successive light pulses remains substantially constant. If the first or second optical sensor 110, 112 is disturbed, for example, by being moved in some way, the birefringence of the optical fiber may change and lead to a change in the amount of light directed back from the disturbed optical sensor into the optical conduit 120. In one embodiment, the optical conduit 120 includes an optical fiber. Since the light is depolarized, the optical conduit 120 is insensitive to being disturbed. For example, the first optical sensor 110 may provide a measure of disturbance localized between the first tap coupler 122 and the end 170 of the first optical sensor 110 at the first mirror 166. Based on the information about the time for the light signal to travel from the transmitter 128 to the end of the optical sensor and then back to the receiver 142, the processor 150 may determine the position of disturbance along the optical conduit 120, e.g., which of the optical sensors is disturbed.

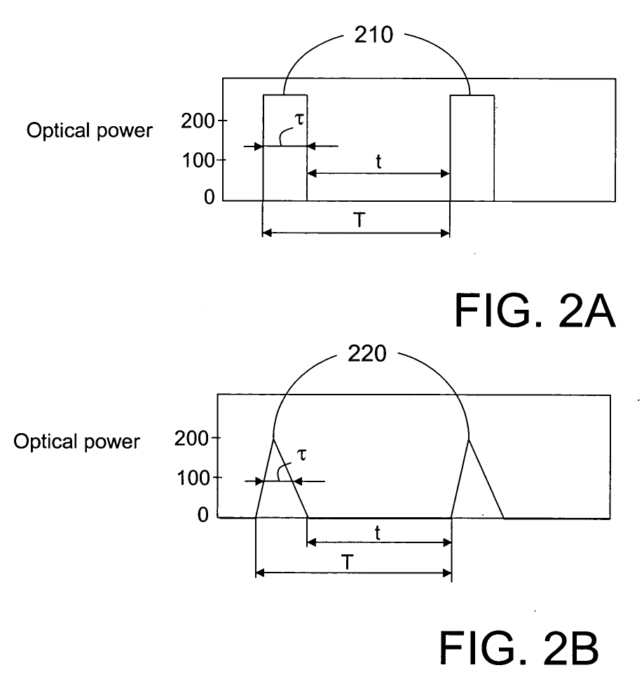

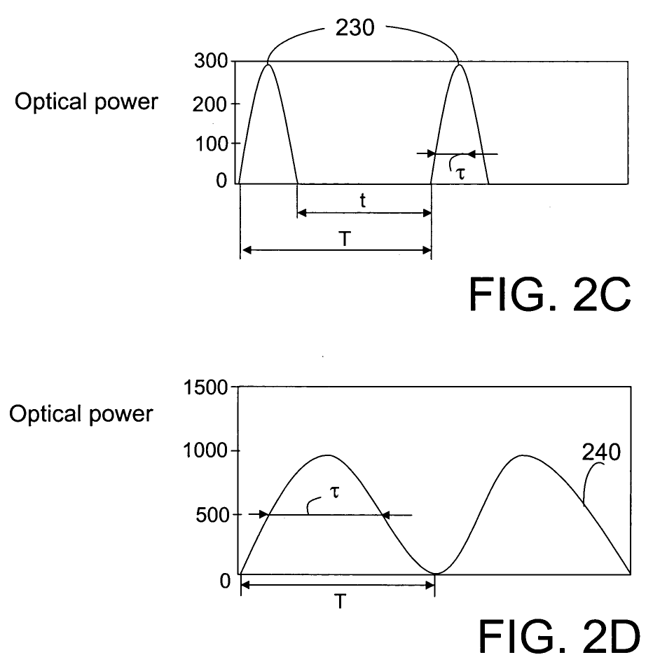

With continuing reference to FIGS. 1A and 1B and further reference to FIGS. 2A, 2B, and 2C, the modulator 148 may manipulate at least one of a shape, a width, a pulse duty factor, and a period or frequency of the transmitted laser pulse to decrease or minimize a number of false optical events. For example, the modulator 148 may control the laser to output a laser pulse with a width or duration r which is less than 100 nsec and less than the minimum distance between reflections coming back from the optical conduit 120. The modulator 148 may control the laser to output a laser pulse with a pulse period T for the laser 128 to be off during a time period t, during which the reflections from the previous pulse come back. Because the laser is ON during only a short period of time, the reflections do not affect the laser. For example, the reflections do not have enough time to come back into the active cavity of the laser and interfere with the laser during transmission. As a result, the noise in the laser signal that could be caused by such reflections can be reduced, substantially minimized or entirely eliminated. In addition, the chirping of the laser signal may broaden the laser spectrum to eliminate standing waves on connecting cables. As a result, the noise and false events caused by the standing waves are eliminated as well.

Table 1 shows some results of testing some models of VCSEL lasers operated in the continuous wave (CW) mode and pulsed mode. While the tested lasers showed unacceptable number of false alarms in the CW mode, the same lasers operated in pulsed mode showed acceptable noise levels as illustrated by an absence of false alarms.

TABLE 1

| | Number of false | Number of false |
|---|---|---|
| | events/hours run | events/hours run |
| Manufacturer and model | when operated | when operated |
| number | in CW mode | in pulsed mode |
| Advanced Optical | >10 alarms/1 hour | 0/2 hours |
| Components, HFE4381-521, | | |
| Lot 1, Laser1 | | |
| Advanced Optical | >10 alarms/1 hour | 0/12 hours |
| Components, HFE4381-521, | | |
| Lot 1, Laser2 | | |
| Picolight, PL-SSC-00-S10- | >10 alarms/1 hour | 0/72 hours |
| C1, | | |
| Laser 1 | | |
| Advanced Optical | >10 alarms/1 hour | 0/12 hours |
| Components, HFE4381-521, | | |
| Lot 2, Laser1 | | |
| Advanced Optical | >10 alarms/1 hour | 0/12 hours |
| Components, HFE4381-521, | | |
| Lot 2, Laser2 | | |
| Picolight, PL-SSC-00-S10- | >10 alarms/1 hour | 0/24 hours |
| C1, | | |
| Laser 2 | | |
| Advanced Optical | — | 0/12 hours |
| Components, HFE4381-521, | | |
| Lot 2, Laser3 | | |
| Picolight, PL-SSC-00-S10- | — | 0/72 hours |
| C1, | | |
| Laser 3 | | |

As illustrated by the test results of Table 1, pulsing a laser may substantially reduce false alarms for fiber-optic perimeter security systems, so that inexpensive lasers, that otherwise are far too noisy, may be used in such systems.

With continuing reference to FIGS. 1A, 1B and 2A, the modulator 148 may control the laser to output a square wave laser pulse 210 which may be transmitted to the first and second optical sensors 110, 112. Table 2 below shows some results of testing the laser using the configuration shown in FIG. 5. For a square wave pulsed signal of 260 mV transmitted by the laser 128, the noise is equal to approximately 31.2 mV. A signal to noise ratio is equal to approximately 8.3.

With continuing reference to FIGS. 1A and 1B and reference again to FIG. 2B, the modulator 148 may control the laser to output a triangular laser pulse 220 which may be transmitted to the first and second optical sensors 110, 112. As shown in Table 2 below, for a triangular pulsed signal of 196 mV transmitted by the laser 128, the noise is equal to approximately 17.3 mV. A signal to noise ratio is equal to approximately 11.3.

With continuing reference to FIGS. 1A and 1B and reference again to FIG. 2C, the modulator 148 may control the laser to output a sinusoidal laser pulse 230 which may be transmitted to the first and second optical sensors 110, 112. As shown in Table 2 below, for a sinusoidal pulsed signal of 313 mV transmitted by the laser 128, the noise is equal to approximately 22.9 mV. A signal to noise ratio is equal to approximately 13.7.

With continuing reference to FIG. 1A and further reference to FIG. 2D, the modulator 148 may manipulate a shape, a width and/or a period or frequency for a continuous wave 240. An example of the continuous wave 240 may include a sinusoidal wave. Generally, frequency of the continuous wave needs to be such that no standing waves form at the drive frequency. For example, if there are two reflections, 50 meters apart, light may take about 500 nsec to travel between the reflections, e.g., round trip time. The modulator 148 may control the laser to output the continuous wave with the frequency which is a non multiple of 1/500 nsec or a non-multiple of 2 MHz. For example, the frequency may be a non-multiple of a driving frequency or equal to approximately 1.3 MHz. As shown in Table 2 below, for a sinusoidal continuous wave of 1013 mV transmitted by the laser 128, the noise is equal to approximately 14.7 mV. A signal to noise ratio is equal to approximately 69.

TABLE 2

| | | | Signal/ |
|---|---|---|---|
| Modulation | Signal | Noise | Noise |
| Square pulse | 260 | 31.2 | 8.3 |
| Triangular Pulse | 196 | 17.3 | 11.3 |
| Sinusoidal Pulse | 313 | 22.9 | 13.7 |
| Sinusoidal CW | 1013 | 14.7 | 69 |

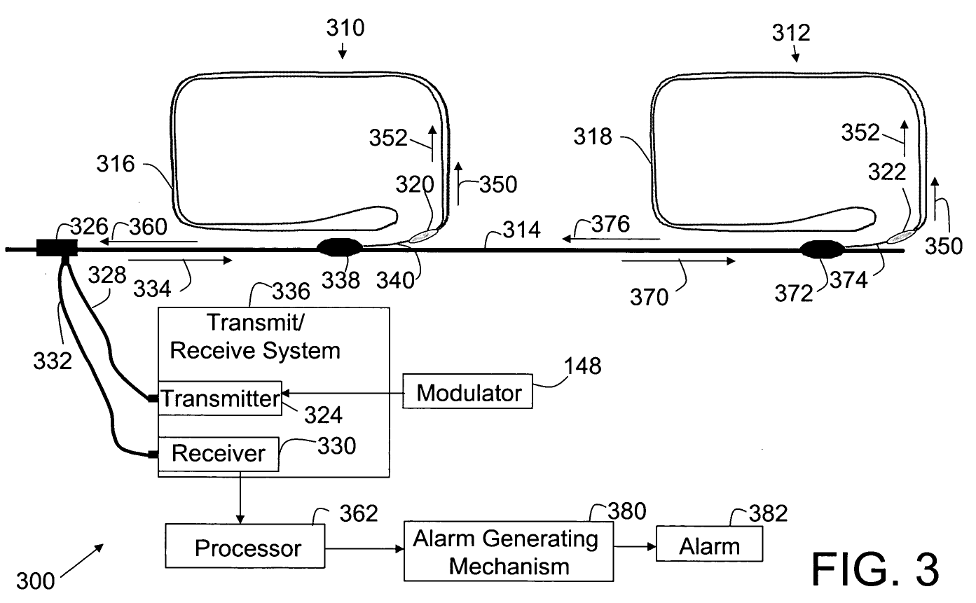

FIG. 3 is a schematic illustration of another embodiment of a fiber-optic detection system 300 according to the current invention. The fiber-optic detection system 300 may include first and second optical sensors 310, 312, each including an interferometer coupled to an optical conduit 314. Each interferometer 310, 312 includes an optical fiber loop 316, 318 optically coupled to a corresponding first or second coupler 320, 322 such as, for example, a 50/50 optical coupler. A transmitter 324 may be connected to the optical conduit 314 via a splitter 326. More specifically, the transmitter 324 may be connected to the splitter 326 via a first portion 328 of a non-sensing single mode optical fiber. A receiver 330 may be connected to the splitter 326 via a second portion 332 of a non-sensing single mode optical fiber. A length of each first, second portion 328, 332 may be 2, 3, 4, or more meters. Light signal 334, transmitted from the transmitter 324 of a transmit-receive system 336, splits off from the optical conduit 314 at a first tap coupler 338 and travels through a portion 340 of the first optical sensor 310. After traveling past a first coupler 320, the light splits to travel in first and second directions 350, 352 around the interferometer loop 316. The counter-rotating beams of light come together at the first coupler 320 and interfere either constructively or destructively with one another while being coupled back into the optical conduit 314 to travel back as a return light 360 to the receiver 330 to be received and processed by a processor 362.

For the second optical sensor 312, a portion of light 370, transmitted past the first tap coupler 338, splits off from the optical conduit 314 at a second tap coupler 372 and travels through a portion 374 of the second optical sensor 312. After traveling past a second coupler 322, the light splits to travel in the first and second directions 350, 352 around the interferometer loop 318. The counter-rotating beams of light come together at the second coupler 322 and interfere either constructively or destructively with one another while being coupled into the optical conduit 314 to travel as a return light 376 to the receiver 330 to be received and processed by the processor 362. Disturbances of each interferometer 310, 312, such as movement, rotation, etc., lead to a change in the interference of the counter-rotating beams at the corresponding coupler 320, 322 and thus lead to a change in the signal returned to the receiver 330. An alarm generating mechanism 380 may generate an alarm 382 to be displayed in a human readable format.

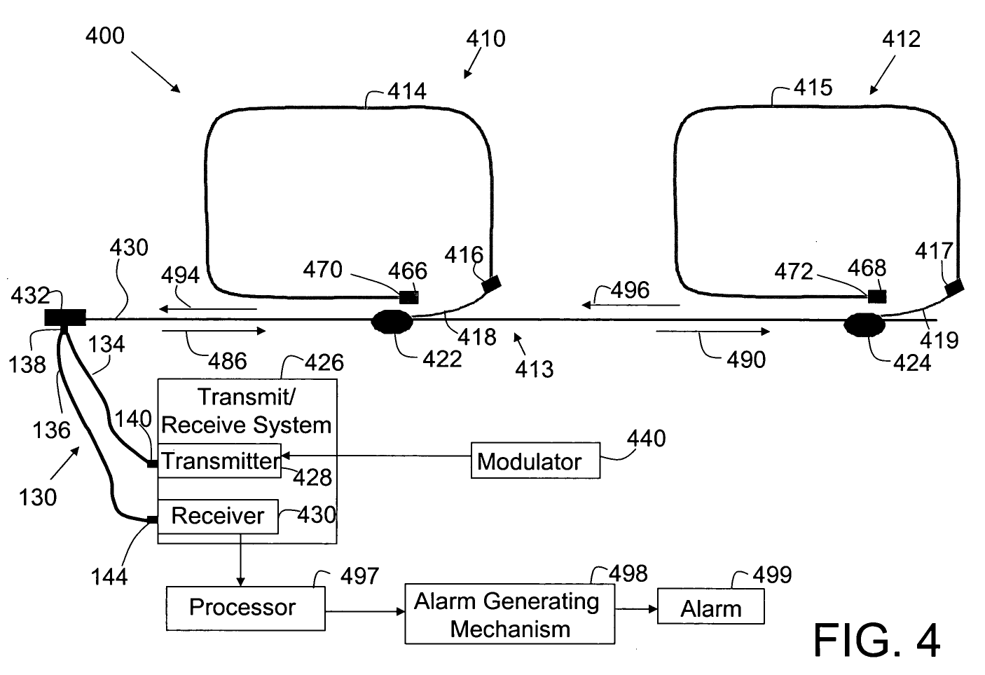

FIG. 4 is a schematic illustration of a fiber-optic detection system 400 according to another exemplary embodiment of the current invention. The fiber-optic detection system 400 may include a spatially distributed detection system including first, second optical sensors 410, 412, similarly to the fiber-optic detection system 100 of FIGS. 1A and 1B, except that a conduit 413 includes a single mode optical fiber while each first, second optical sensor 410, 412 includes at least one length of a multimode optical fiber 414, 415. Each multimode optical fiber 414, 415 is fusion spliced through a corresponding optical coupler 416, 417 into a single mode fiber section 418, 419 to optically couple to the optical conduit 413 at a respective first or second tap splitter 422, 424 to receive light signals from a transmit-receive system 426 including a transmitter 428. The optical conduit 413 may include be coupled to the transmitter 428 and a receiver 430 via a splitter 432. In operation, the single mode optical fiber of the optical conduit 413 provides spatial filtering of a time-varying speckle pattern returned from the optical sensors 410, 412.

Similarly to the embodiments of FIGS. 1A and 1B, the transmitter 428 may include a pulsed laser, a continuous wave laser, or the like source of light and may be controlled by a modulator 440 as described above with reference to FIGS. 2A, 2B, 2C and 2D. Examples of the laser may include a vertical cavity surface emitting laser (VCSEL), a Fabry Perot (FB) laser, a distributed feedback (DFB) laser, and the like.

In one embodiment, first, second mirrors 466, 468 each may be disposed at first, second end 470, 472 of the respective first, second optical sensor 410, 412. The first, second mirrors 466, 468 may be either formed on the end 470, 472 of the respective first, second optical sensor 410, 412, may be a component that is attached to the end 470, 472 of the respective first, second optical sensor 410, 412, or may include a layer of reflective material disposed about the end 470, 472 of the respective first, second optical sensor 410, 412 as described above.

The transmitter 428 may provide a source of light indicated by an arrow 486. The first, second splitters 422, 424 each may split off a portion of light transmitted in the conduit 413 to direct the light into the respective first, second optical sensor 410, 412.

When the light signal 486 reaches the first splitter 422, a portion of the light is split off into the first optical sensor 410 and the rest of the light, indicated by an arrow 490, travels further in the conduit 413. The light travels along the length of the first optical sensor 410 to the first mirror 466. The light reflects back off the first mirror 466 into the conduit 413 at the first tap splitter 422 as a first return light 494 to be received by the receiver 430.

The process described above in relationship to the first optical sensor 410 may be repeated for the second optical sensor 412 and other optical sensors which may be disposed along the optical conduit 413. Correspondingly, a respective first, second return pulse 494, 496 of light is received from each optical sensor 410, 412 by the receiver 430 for a given light signal from the transmitter 428. A processor 497 may receive electrical signals from the receiver 430 and process the received electrical signals to determine, for example, the presence of an event sensed by one or more optical sensors 410, 412. An alarm generating mechanism 498 may generate an alarm 499 to indicate a presence of an undesirable event.

It is contemplated that optical fibers that change their optical properties in the presence of certain chemical agents may be used in the embodiments described above. For example, optical fibers that change their optical density in the presence of certain chemical agents may be used. Optical fibers that darken, i.e., increase attenuation, in the presence of chlorine gas may be used as another example. For example, changes in the optical density of one or more of the optical sensors due to the presence of a chemical agent may lead to the detected changes in the received pulses.

Many modifications and alternatives to the illustrative embodiments described above are possible without departing from the scope of the current invention, which is defined by the claims.

1. An optical detection system, comprising:
an optical transmit-receive system;
an optical conduit in optical communication with the optical transmit-receive system; and
an optical sensor in optical communication with said optical conduit,
wherein said optical transmit-receive system provides pulsed optical signals to said optical sensor by way of said optical conduit that have a maximum pulse width of about 100 nanoseconds and further have a maximum pulse width that is less than a maximum distance of reflection of said pulsed optical signals in said optical detection system to thereby decrease false alarms.

2. The optical detection system according to claim 1, wherein said optical transmit-receive system comprises an optical transmitter.

3. The optical detection system according to claim 2, wherein said pulsed optical signals have a pulse repetition rate selected such that said optical transmitter is off when all reflections from each pulse return to said optical transmit-receive system.

4. The system according to claim 1, wherein the shape of the pulsed light signals comprises at least one of a square, a triangle, or a sinusoid.

5. The system according to claim 1, wherein the transmit-receive system comprises a component to generate the pulsed optical signals when forward biased and detect the reflected portions of said pulsed optical signals when reverse biased.

6. The system according to claim 1, wherein the transmit-receive system comprises at least one of:
a distributed feedback (DFB) laser, or
a Fabry Perot (FB) laser.

7. The system according to claim 1, wherein the transmit-receive system comprises a vertical cavity surface emitting laser (VCSEL).

8. The system according to claim 1, wherein the optical sensor comprises optical fiber adapted to establish a detection zone.

9. The system according to claim 1, further comprising:
a first optical sensor in optical connection to the optical conduit at a first location; and
a second optical sensor in optical connection to the optical conduit at a second location,
wherein a time between transmission and reception of the pulse of light from the pulsed signals provides information to determine a position of coupling of at least one of the first or second optical sensor to the optical conduit.

10. An optical detection system, comprising:
an optical transmit-receive system;
an optical conduit in optical communication with the optical transmit-receive system; and
an optical sensor in optical communication with said optical conduit,
wherein said optical transmit-receive system provides a continuous wave optical signal to said optical sensor by way of said optical conduit to be returned to said optical transmit-receive system for detection, and
wherein said continuous wave optical signal is selected to have a frequency such that there is no optical standing wave from any optical reflections within said optical detection system.

11. The system according to claim 10, wherein the transmit-receive system comprises at least one of:
a distributed feedback (DFB) laser, or
a Fabry Perot (FB) laser.

12. The system according to claim 10, wherein the transmit-receive system comprises a vertical cavity surface emitting laser (VCSEL).

13. The system according to claim 10, wherein the optical sensor comprises an optical fiber adapted to establish a detection zone.

14. The system according to claim 10, further comprising:
a first optical sensor in optical connection to the optical conduit at a first location; and
a second optical sensor in optical connection to the optical conduit at a second location,
wherein a time between transmission and reception of light provides information to determine a position of coupling of at least one of the first or second optical sensor to the optical conduit.

15. An optical detection system, comprising:
an optical transmit-receive system;
an optical conduit in optical communication with the optical transmit-receive system; and
an optical sensor in optical communication with said optical conduit,
wherein said optical conduit comprises a single mode optical fiber and said optical sensor comprises a multimode optical fiber, and
wherein, in operation, said single mode optical fiber of said optical conduit provides spatial filtering of a time-varying speckle pattern from the optical sensor.

16. The system according to claim 15, further comprising:
a first optical sensor in optical connection to the optical conduit at a first location; and
a second optical sensor in optical connection to the optical conduit at a second location,
wherein a time between transmission and reception of light provides information to determine a position of coupling of at least one of the first or second optical sensor to the optical conduit.

17. A method of detecting an intruder, comprising:
directing a pulse of light into an optical conduit;
splitting off a portion of said pulse of light into an optical sensor, wherein said optical sensor is structured to reflect light back into said optical conduit; and
detecting a return portion of said pulse of light after having been reflected back by said optical sensor,
wherein said pulse of light has a width that is less than a minimum distance of reflection, and
wherein said width of said pulse of light is also less than about 100 nanoseconds.

18. The method according to claim 17, wherein the pulse of light is generated by at least one of:
a distributed feedback (DFB) laser, or
a Fabry Perot (FB) laser.

19. The method according to claim 17, wherein the pulse of light is generated by a vertical cavity surface emitting laser (VCSEL).

20. A method of detecting an intruder, comprising:
directing a beam of continuous wave light into an optical conduit;
splitting off a portion of said beam of continuous wave light into an optical sensor, wherein said optical sensor is structured to reflect light back into optical conduit; and
detecting a return portion of said beam of continuous wave light after having been reflected back by said optical sensor,
wherein said beam of continuous wave light has a frequency selected such that there is no optical standing wave from any optical reflections received during said detecting.

21. The method according to claim 20, wherein the beam of light is generated by at least one of:
a distributed feedback (DFB) laser, or
a Fabry Perot (FB) laser.

22. The method according to claim 20, wherein the beam of light is generated by a vertical cavity surface emitting laser (VCSEL).

23. A method of detecting an intruder, comprising:
directing light into a single mode optical fiber;
splitting off a portion of said light into an optical sensor, wherein said optical sensor comprises multimode optical fiber and is structured to reflect light back into said single mode optical fiber; and
detecting a return portion of said light after having been reflected back by said optical sensor,
wherein said single mode optical fiber provides spatial filtering of a speckle pattern of light from said optical sensor, and
wherein said detecting is based on a time-varying signal obtained from said spatial filtering of said speckle pattern.
